(19) United States
(12) Patent Application Publication
(10) Pub. No.: US 2026/0028295 A1
(43) Pub. Date: Jan. 29, 2026

(54) COMPOSITIONS THAT CONTAIN SUSPENDED DICYANDIAMIDE, AND RELATED METHODS

(71) Applicant: Keystone Specialty Chemicals LLC, Hillsborough, NJ (US)

(72) Inventors: Leahann Iannotta, Wayne, PA (US); Rajesh Pazhianur, Belle Mead, NJ (US)

(73) Assignee: Keystone Specialty Chemicals LLC, Hillsborough, NJ (US)

(21) Appl. No.: 18/998,028

(22) PCT Filed: Jul. 24, 2023
(86) PCT No.: PCT/US2023/070836

§ 371 Date: Jan. 23, 2025

Related U.S. Application Data
(60) Provisional application No. 63/391,958, filed on Jul. 25, 2022.

(51) Int. Cl. C05G 3/90; C05C 9/00; C05G 5/27

(52) U.S. Cl. CPC C05G 3/90; C05C 9/00; C05G 5/27

(57) ABSTRACT

Described are compositions (“suspensions”) that contain dicyandiamide (DCD) suspended in particle form in an liquid medium, with optional urease inhibitor, biostimulator, or micronutrient also contained (e.g., dissolved) in the liquid medium, as well as methods of preparing the compositions, methods of using the compositions, and fertilizer products that contain the compositions.

This application claims priority to U.S. Provisional Application No. 63/391,958, filed Jul. 25, 2022, entitled “COMPOSITIONS THAT CONTAIN SUSPENDED DICYANDIAMIDE, AND RELATED METHODS”, the entire disclosure of which is incorporated herein by reference for all purposes.

### FIELD OF THE INVENTION

This description relates to compositions (“suspensions”) that contain dicyandiamide (DCD) that is suspended in particle form in a liquid medium, as well as methods of preparing the compositions and methods of using the compositions.

### BACKGROUND

Commonly-used nitrogen-based fertilizers include urea, ammonium nitrate, ammonium phosphate, among others. Nitrogen-based fertilizers are well understood to exhibit a drawback of being potentially lost to the atmosphere (soil, drainage, or air) by way of volatilization or denitrification, unless these possibilities are controlled. By volatilization, a nitrogen-based fertilizer such as urea applied as fertilizer to soil is susceptible to hydrolysis, by which urea is converted to gaseous ammonia and carbon dioxide. The reaction is catalyzed by the enzyme urease, which is produced by certain bacteria and fungi and can be present in soil. The gaseous ammonia escapes to the atmosphere as volatilized ammonia and is not effective as fertilizer. By denitrification, a nitrogen-based fertilizer compound is converted to a nitrite or nitrate and then lost to the environment by leaching, runoff, or volatilization (i.e., denitrification loss).

To prevent loss by denitrification, compounds referred to as “nitrification inhibitors” can be combined with a nitrogen-based fertilizer. An example of a nitrification inhibitor is dicyandiamide (“DCD”). When applied with a nitrogen-based fertilizer, DCD can help prevent the loss of nitrogen through denitrification and leaching.

Dicyandiamide has been combined with fertilizer by various techniques. By one method, DCD may be dissolved in organic solvent such as dimethyl sulfoxide (DMSO) or n-methyl pyrrolidone, and the solution of DCD dissolved in the organic solvent can be combined with a urea or a urea-ammonium nitrate fertilizer. See United States patent publication 2014/0174140. Dicyandiamide exhibits low solubility in water and is difficult to dissolve in an aqueous fertilizer composition. By a different method that avoids a step of dissolving dicyandiamide, the dicyandiamide can be added to molten urea and granulated. See, e.g., U.S. Pat. No. 5,352,265. This eliminates the need to dissolve the DCD in an organic solvent.

To prevent the loss of urea-based fertilizer by conversion of urea to ammonia, which is volatile, a urease inhibitor may be included in a nitrogen-based, e.g., urea-based fertilizer. The urease inhibitor can prevent conversion of the urea by urease to gaseous ammonia, preventing the loss of nitrogen from the fertilizer to the atmosphere. Preventing conversion of the urea to ammonia will increase the amount of urea (and, necessarily, nitrogen) from the fertilizer that remains in the soil for absorption by a crop plant, making the urea available to plants in the soil for an extended time period. Increasing the amount of time that the urea is available to the plant increases the effectiveness of the fertilizer, which improves crop yield and quality. Among effective urease inhibitors are the thiophosphoric triamide compounds, including alkyl thiophosphoric triamide compounds such as N-alkyl thiophosphoric triamides. The compound N-(n-butyl)thiophosphoric triamide (NBPT) is the most common species of thiophosphoric triamide compounds currently used in commercial agriculture.

For convenience and efficiency, a concentrated dicyandiamide product that contains DCD as a nitrification inhibitor may also include a urease inhibitor such as NBPT. Such a two-component system can be conveniently added to a nitrogen-based or a urea-based fertilizer prior to application, to reduce or prevent both volatilization loss and loss by denitrification.

### SUMMARY

Concentrated dicyandiamide products are widely available in the form of liquid solutions that contain dicyandiamide dissolved in a liquid organic solvent. Concentrated dicyandiamide products are not widely available as suspensions, which contain the dicyandiamide particles in a solid form dispersed (suspended) uniformly throughout a liquid that does not dissolve the dicyandiamide.

Two common solvents that are used to form solutions that contain dissolved dicyandiamide are dimethyl sulfoxide and n-methyl pyrrolidone. These solutions are significantly stable and can dissolve a useful concentration of dicyandiamide. For example, a solution that contains 30 weight percent dicyandiamide in DMSO has an extremely low freeze point (<30 degrees Celsius) which is advantageous for storage during winter.

Advantageously, a solution of dicyandiamide dissolved in organic solvent does not suffer from risks that are associated with concentrated suspensions that contain un-dissolved, solid dicyandiamide particles dispersed throughout a liquid medium. These risks include the possibility of particles settling out of the suspension under the influence of gravity, and particle agglomeration or coagulation (thermodynamically driven). These risks can be further increased due to the effect of Ostwald's ripening, which over time can cause an increase in size of suspended particles and an increased tendency for particles to settle out of suspension, particularly when the suspension contains some amount of water.

The need to dissolve dicyandiamide in an organic solvent to form a liquid solution requires reliable and cost-effective availability of solvent that can dissolve a high concentration of dicyandiamide. The most common solvents for concentrated dicyandiamide products are dimethyl sulfoxide and n-methyl pyrrolidone. Few other solvents are effective to dissolve a concentrated amount of dicyandiamide.

With only a couple of solvents being predominantly used for these solution-type dicyandiamide products, the Applicant has identified alternative forms of concentrated dicyandiamide products in the form of suspensions that contain concentrated amounts of dicyandiamide particles suspended (not completely dissolved) in a liquid medium. Examples of the described suspensions include suspended dicyandiamide particles having a relatively small average particle size. As described, the Applicant has determined that controlling or selecting size features of suspended dicyandiamide particles (e.g., using particles of relatively smaller average particle size, or particles that have a unimodal or a narrow particle size distribution) can reduce the effects of Ostwald's ripening on the suspended particles. With the reduced effect of Ostwald's Ripening, the suspensions experience less settling of the suspended dicyandiamide particles over time, e.g., during storage, meaning increased stability during periods of storage.

The term “suspension” refers to a heterogeneous liquid composition that contains solid particles (dicyandiamide) distributed throughout a liquid carrier. A suspension that is “homogeneous” contains particles that are distributed substantially uniformly throughout the liquid carrier, with no particles settled at a bottom of a suspension, and with approximately the same concentration (within 5, 2, or 1 percent by weight) of particles being present in samples taken from different locations of a suspension in a container, e.g., a sample taken from an upper portion of a container can have a concentration of suspended dicyandiamide that is the same as a second sample taken from a lower portion of the same container. For clarity, a concentration of a second sample is “within 5 percent by weight” of a concentration of a first sample if the measured concentration of the second sample is not more 5 percent higher than and not more than 5 percent lower than the measured concentration of the first sample; e.g., if the concentration of the first sample is 30 weight percent, the concentration of the second sample may be in a range from 28.5 weight percent to 31.5 weight percent.

Examples of useful or preferred concentrates of this description can have a relatively high concentration of dicyandiamide, e.g., at least 20, 25, 30, 35, 40, or 50 weight percent dicyandiamide based on total weight liquid concentrate.

Examples of useful or preferred liquid concentrates may contain dicyandiamide particles in combination with a urease inhibitor. The urease inhibitor may be included in any useful amount, e.g., at least 1, 3, 5, 10, 15, 20, or 25 weight percent urease inhibitor based on total weight concentrate.

Examples of useful or preferred liquid concentrates may contain dicyandiamide particles in combination with one or more biostimulants. The one or more biostimulants may be present in any useful amount, e.g., at least 1, 3, 5, 10, 15, 20, or 25 weight percent biostimulant based on total weight concentrate.

Useful or preferred liquid concentrates can exhibit good stability during storage by remaining in a form of a stable and homogeneous suspension, or by exhibiting a stable average particle size that does not increase during storage by an unacceptable amount as described herein, or by experiencing an acceptably low amount of settling out of dicyandiamide particles as sediment (solid residue) at a bottom of a container.

On one aspect, the invention relates to a liquid dicyandiamide concentrate that contains: liquid medium, dispersant, suspending agent, and dicyandiamide particles suspended in the liquid medium.

In another aspect, the invention relates to a method of preparing a liquid concentrated dicyandiamide adjuvant. The method includes combining dicyandiamide particles having an average particle size below 30, 20, or 10 microns with liquid medium, dispersant, and suspending agent to form a suspension that includes the dicyandiamide particles suspended in the liquid medium.

### DETAILED DESCRIPTION

The following description relates to liquid compositions that contain dicyandiamide particles suspended in a liquid medium. Such a liquid composition may also, optionally, include urease inhibitor dissolved in the liquid medium, optional biostimulant dissolved or suspended in the liquid medium, micronutrients, plant growth regulators, or a combination of these. Any of the described versions of the liquid compositions may be referred to as a “concentrated dicyandiamide composition,” a “concentrated dicyandiamide product,” “dicyandiamide concentrate,” or simply a “liquid concentrate,” or “concentrate.” The liquid concentrate contains dicyandiamide particles suspended in the liquid medium and in this respect may also be referred to as a “liquid suspension,” a “suspension,” or a “dispersion.”

The description also relates to fertilizer compositions (a.k.a. “fertilizer products”) that contain a concentrated dicyandiamide product with optional urease inhibitor, biostimulant, micronutrient, plant growth regulator, or combinations of these, combined with fertilizer, prepared by combining the concentrated dicyandiamide product (or a derivative thereof) with the fertilizer.

Dicyandiamide is a chemical compound that is known to be effective as a nitrification inhibitor, and has the chemical formula (I):

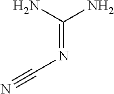

Dicyandiamide, also known as “2-cyanoguanidine,” can be made by known methods of treating cyanamide with base and is commercially available. Dicyandiamide (“DCD”) can be provided in the form of concentrated particles, e.g., a collection of particles, flakes, pellets, or granules, etc., that contain a high concentration of dicyandiamide, e.g., at least 90, 95, or 99 weight percent dicyandiamide. Dicyandiamide in the form of concentrated particles also preferably contains a low amount of moisture, such as less than 5, 2, or 1 weight percent water, based on the total weight dicyandiamide particles.

Optionally, a liquid concentrate as described can include urease inhibitor dissolved in the liquid medium. One class of effective urease inhibitors are phosphoric triamide compounds disclosed in the U.S. Pat. No. 4,530,714, which include alkyl thiophosphoric triamide compounds such as N-alkyl thiophosphoric triamides. The compound N-(n-butyl)thiophosphoric triamide (NBPT) is the most common species of thiophosphoric triamide compound currently used in commercial agriculture. In useful or preferred embodiments, a urease inhibitor can be included in a liquid concentrate in a dissolved form, being dissolved in the liquid medium. To include dissolved urease inhibitor in the concentrate, the liquid medium can include an amount of one or more different types of organic solvent that is capable of solubilizing the urease inhibitor.

Optionally, a liquid concentrate as described can include biostimulant that is dissolved or suspended in the liquid medium. Agricultural biostimulants (or simply “biostimulants”) are biologically-sourced agricultural additives that may be useful in crop production to enhance plant nutrition, health, growth, quality, or productivity (e.g., yield). The term “agricultural biostimulant” refers to a diverse group of chemical materials that may be derived from naturally occurring organisms, microorganisms, or organic matter, and that will have different modes of action when presented to a plant or soil as a biostimulant.

According to one definition, provided by The European Biostimulants Industry Council (EBIC), biostimulants are identified as follows: “Agricultural biostimulants include diverse formulations of compounds, substances and micro-organisms that are applied to plants or soils to improve crop vigor, yields, quality and tolerance of abiotic stresses. Biostimulants foster plant growth and development throughout the crop life cycle from seed germination to plant maturity in a number of demonstrated ways, including but not limited to: Improving the efficiency of the plant's metabolism to induce yield increases and enhanced crop quality; Increasing plant tolerance to and recovery from abiotic stresses; Facilitating nutrient assimilation, translocation and use; Enhancing quality attributes of produce, including sugar content, color, fruit seeding, etc.; Rendering water use more efficient; Enhancing soil fertility, particularly by fostering the development of complementary soil micro-organisms.”

In alternate terms, agricultural biostimulants include compounds or substances that can be applied to a plant or soil to regulate and enhance a crop's physiological processes, thus making the physiological processes more efficient and improving a feature of the crop. A biostimulant may act on plant physiology through any of various physiological pathways to improve a feature of a crop such as crop vigor, yield, quality (e.g., size, coloration, or nutritional content), post-harvest shelf life, or some other feature. Some biostimulants are effective to stimulate the root zone of a plant, producing a positive effect on the plant's overall health by increasing the uptake of vital nutrients to the plant. Other biostimulants affect a property of the soil, such as to improve the ability of the soil to retain moisture or nutrients and deliver those to a plant. Some identifiable groups of biostimulants include humic materials, amino acids, plant sugars, seaweeds and seaweed extracts, mycorrhizal fungi, trace elements, and growth promoting hormones.

As used herein and based on the described use of the term “biostimulant,” a biostimulant can be distinguished from an active herbicide ingredient (sometimes referred to collectively as “herbicides” or “active herbicides” or “AIs” or specifically as “synthetic herbicides”) that are not biologically-sourced, i.e., are produced by a chemical synthesis route. Active herbicides are chemical compounds that do not fall within the scope of the term “biostimulant,” i.e., are not biologically sourced compounds and also are not effective to enhance plant nutrition, health, growth, quality, or productivity (e.g., yield). Active herbicide ingredients are well known and as opposed to promoting plant nutrition, health, growth, or quality are typically synthetic molecules that are effective kill an unwanted biological entity such as an insect, weed, mold, rodent, microorganisms (e.g., bacteria, viruses), algae, or fungus, etc.

The biostimulant may be any known or useful biostimulant. Various types are known, including those that contain humic substances, individual or combinations of free (molecular) amino acids and polypeptides (e.g., protein hydrolysates), and seaweed extracts. An example of a class of useful biostimulants are those that include a combination of free amino acids and polypeptides and that are derived by hydrolyzing protein (chemically or enzymatically) that may be obtained from an animal or plant source, referred to as “protein hydrolysates.”

Biostimulant products are commercially available under various tradenames. A commercial biostimulant product generally includes a biologically-active material (e.g., free amino acid, polypeptide, enzyme, etc.), in a concentrated amount, optionally in combination with other ingredients such as a liquid carrier.

Amino acid biostimulants are compositions that include a high level of free amino acids, polypeptide, or both. Biostimulants are commercially available under various tradenames, including Amefert; Protaminal®; Essential Plus® 1-0-1 (from Growth Products, Ltd.); delfan plus; Biomax, Biomax Solid, and Aminogreen (from AGRI Nova, Spain); WUXAL biostimulants (from AGLUKON); among others.

Amino acid biostimulant products can include a concentrated amount (e.g., at least 5, 10, 15, 20, 30, 40 weight percent, or up to or exceeding 50, 70, or 90 weight percent (for concentrated solid compositions)) of free amino acid, polypeptide, or both, optionally in combination with other ingredients such as a liquid carrier. For example, some amino acid biostimulant products include high levels (e.g., as mentioned above) of free L-amino acids such as L-glycine, L-glutamic acid, L-aspartic acid, L-alanine, L-proline, L-leucine, or combinations of these.

One preferred biostimulant product for use as described is an amino acid and polypeptide biostimulant product sold under the trade name Protifert LMW 9 from Sicit 2000 (Italy). This biostimulant product is sold under the generic CAS number 9015-54-7 “protein hydrolysates.” It can be prepared by hydrolyzing bovine hides/skin and once hydrolyzed results in a blend of free amino acids and polypeptides. This product (through the nature of the bovine material and the extent of the hydrolysis) can contain about 60 weight percent organic matter in solution, based on total weight of the biostimulant product (organic matter and other components, such as liquid (e.g., water)). Still using a total product weight basis, about 50 weight percent of the biostimulant product (on a total product basis) is organic, amino acid-based material (this includes both free amino acids and polypeptides). Of the 50 weight percent (total product basis) that is amino acid-based material, about 10 to 20 weight percent (on total product basis) of the biostimulant product may be free amino acid and about 30 to 40 weight percent (on total product basis) of the biostimulant product may be polypeptide.

On a basis of free amino acids and polypeptides, example amino acid biostimulants may contain any useful relative amounts of amino acid and peptide, such as from 5 to 70 (e.g., from 15 to 60 or from 20 to 50) weight percent free amino acids and from 30 to 95 (e.g., from 40 to 85 or from 50 to 80) weight percent polypeptides based on combined total weight amino acid and polypeptide.

Other useful biostimulant products include those that contain a high level of humic substances, meaning humic acids, fulvic acids, humin, or a combination of these. Commercially available humic substance-based biostimulant products may include at least 5, 10, 20, 30, 40, or 50 weight percent humic substances, i.e., humic acids, fulvic acids, humin, or a combination thereof, based on total weight of the biostimulant product. Humic acids, fulvic acids, and humin, are created by the natural degradation of organic matter. A typical humic substance is a mixture of many molecules, some of which are based on arrangements of multiple aromatic compounds having phenolic and carboxylic substituents, linked together. The molecules can exhibit a charge at one or more carboxylic groups. Humic substances are considered to act as biostimulants by increasing nutrient retention in the soil, because the humic substances have a high cation exchange capacity. Additionally, humic substances may modify soil structure by rearranging soil platelets, or may provide a slow-release food source for microbial activity and stimulate root growth.

Still other useful biostimulant products include those that are derived from seaweed, these being referred to as seaweed extracts. Seaweed extracts may act as a biostimulant due to the presence of plant hormones. Bioactive ingredients, e.g., phytohormones, identified in seaweed extracts include auxins, cytokinins, gibberelins, abscisic acid, ethylene, and betaines. Auxins may contribute to elongational growth of plant tissues and apical dominance, cell division, plant movements and plant aging. Cytokinins can be involved in cell division regulation affecting plant growth; moreover, they may inhibit aging of plant tissues and play a role in transport of nutrients. Functions of gibberellins include initiation of seed germination, growth regulation, braking bud dormancy, florescence, and fruits development. Abscisic acid and ethylene may contribute to: response to stress factors, inhibition of cell growth, and acceleration of plant aging. Abscisic acid is also believed to participate in regulation of seed germination. Seaweed extracts commonly used for biostimulant products include red algae: Corralina mediterranea, Jania rubens, Pterocladia pinnata; green algae: Cladophora dalmatica, Enteromorpha intestinalis, Ulva lactuca; and brown algae: Ascophyllum nodosum, Ecklonia maxima, Saragassum.

Biostimulant may be present in a liquid concentrate in a dissolved form when the biostimulant is soluble in the liquid medium—many biostimulants are soluble in water and will be dissolved in a liquid medium that contains water. Alternately, biostimulant may be present in a liquid concentrate in the form of solid (un-dissolved) particles dispersed within a liquid medium, if the biostimulant is not soluble in the liquid medium. Biostimulant may be present in a liquid concentrate in any useful amount, e.g., up to or greater than 1, 3, 5, 10, 15, 20, or 25 weight percent biostimulant based on total weight concentrate.

The concentrate may contain one or more plant growth regulators (also referred to as a “plant hormone,” “plant growth hormone,” “growth regulator,” “phytohormone,” or “PGR”). A “plant growth regulator” as this term is used herein refers to a natural or synthetic chemical that can be applied to a plant to affect a biological function of a plant, such as to modify metabolic, growth, maturing, or ripening of the plant. Plant growth regulators are sometimes grouped into five classes based on their chemical makeup and what they cause to occur or prevent from occurring in a plant. These are abscisic acid, auxins, cytokinins, gibberellins, and ethylene. Specific examples include gibberellic acid, IBA (indole-3-butyric acid, 1H-indole-3-butanoic acid), 6-benzylaminopurine (6-ba), CPPU (forchlorfenuron), Prohexadione calcium, and others. The amount of biostimulant in a concentrate composition can be any effective amount.

The concentrate composition may also contain one or micronutrients. A “micronutrient” is a type of chemical material that is considered to be useful or even essential for plant growth, e.g., by providing balanced crop plant nutrition. Specific examples of micronutrients include boron (B), copper (Cu), iron (Fe), manganese (Mn), molybdenum (Mo), zinc (Zn), nickel (Ni) and chloride (Cl).

A micronutrient may be included in a concentrate composition in any of various useful chemical forms, including elemental forms, ionic forms, and chemical compounds. Boron may be present, for example, as boron, boric acid, or borax. Zinc may be present as a zinc chelate, zinc oxide, zinc oxysulfate, as a zinc polyflavonoid, or as zinc sulfate. Manganese may be present as a manganese chelate (e.g., MnEDTA), manganese oxide, manganese oxysulfate, or manganese sulfate. Iron may be present as ferrous ammonium phosphate, ferrous ammonium sulfate, or as an iron chelate. Copper may be present as a copper chelate, a copper sulfate (e.g., monohydrate or pentahydrate), cupric ammonium phosphate, cupric chloride, cuprous oxide, or as a copper polyflavonoid. Molybdenum may be present as ammonium molybdate, molybdenum trioxide, molybdenum dioxide, or as sodium molybdate. Chlorine may be present as calcium chloride or potassium chloride. Micronutrients are different from macronutrients and secondary macronutrients nitrogen, potassium, phosphorus, calcium, magnesium, and sulfur. The amount of micronutrient in a concentrate composition can be any effective amount.

In various examples, a concentrated dicyandiamide product can be in the form of a “liquid concentrate” (or simply “concentrate”) that contains a concentrated amount of suspended dicyandiamide with optional biostimulant, urease inhibitor, micronutrient, etc. The dicyandiamide is present mostly in the form of solid particles that are suspended in a liquid medium. In addition to the suspended particles, dicyandiamide has at least a low level of solubility in various liquid mediums that contain water, organic solvent, or both. Dicyandiamide is listed as having a solubility of 4.13 grams per 100 milliliter in water at 25 degrees Celsius. As a result, an amount of dicyandiamide may be dissolved in a liquid medium that includes water or another liquid.

A system of solid dicyandiamide particles suspended in a liquid medium (whether aqueous or non-aqueous) in which the dicyandiamide has a degree of solubility (e.g., is partially soluble) allows for the dicyandiamide to pass alternately between a solid and a liquid state, which allows for an undesired phenomenon referred to as “Ostwald's Ripening.” Very generally, Ostwald's Ripening is a phenomenon observed in liquid suspensions that results in a change of physical form of suspended particles over time as smaller particle dissolve and redeposit onto larger particles within the system.

In the context of the present liquid concentrates, Ostwald's Ripening can be detected as an increase in average particle size of dicyandiamide particles that are suspended within a liquid concentrate. Ostwald's Ripening can also be detected as a resulting increase over time, e.g., during storage, of solid residue that accumulates at a bottom of a container that contains the concentrate. Larger particles formed by Ostwald's Ripening tend to fall out of suspension and accumulate at a bottom of a container that holds the concentrate.

Of dicyandiamide particles that are originally present in the suspension, dicyandiamide particles of smaller sizes, at a lower end of a particle size distribution range of the suspended particles, may completely dissolve within the liquid medium during storage. The dissolved dicyandiamide of the small particles does not re-form as a newly-generated small particle that replaces the dissolved particle. Instead, dicyandiamide that becomes dissolved in the liquid medium by a small particle being completely dissolved may re-deposit out of the dissolved state by precipitating on an already-present particle, which causes that particle to become larger. Over time, the smallest particles in the suspension are removed by being completely dissolved. Larger particles increase in size as the dicyandiamide that is in solution from the dissolved smaller particles is re-deposited onto the larger particles. The result is an increase in the average particle size of the suspended dicyandiamide particles and a shift of the particle size distribution of the particles in a direction toward larger particles. As another result, some larger-sized particles present in the suspension due to Ostwald's Ripening may become settled as solid residue at a bottom of a container that contains the suspension.

A concentrated dicyandiamide product as described can be susceptible to various forms of instability when the product is contained in a container over a period of time (referred to as a “storage period”), particularly for a period of multiple months. Forms of instability include gravitational settling of dicyandiamide particles out of suspension, which may be caused by or increased by Ostwald's Ripening; increased average particle size caused by Ostwald's Ripening; increased viscosity; and chemical instability of the dicyandiamide compound during storage. Examples of liquid concentrates as described can exhibit useful or improved levels of stability relative to one or more of these forms of instability.

By tests as described, preferred liquid concentrates can be considered to be stable to various types of instability for test periods of 3, 6, 9, 12, 18 or 24 months, at one or at multiple temperature conditions, such as at 0, 20, and 45 degrees Celsius. These periods and temperatures can be used for measuring stability of concentrates for any one or more of the stability tests described herein and can be referred to as “storage test periods.”

A concentrated dicyandiamide product as described can exhibit useful stability against Ostwald's ripening as measured by a change in average particle size of dicyandiamide particles within a suspension during a storage period. Concentrated dicyandiamide products are prepared to contain dicyandiamide particles having an initial average particle size and an initial particle size distribution. These features of the particles can be selected and controlled in a manner that reduced Ostwald's Ripening and improves stability of a concentrate during storage or by testing, such as by preparing a concentrate to contain particles of relatively smaller sizes and having a controlled size distribution. During stability testing, using multiple storage test periods, the size of particles in a suspension can be measured to assess particle size stability. Particle size distribution, average particle size, etc., of dicyandiamide particles in a suspension can be measured by known techniques and using known particle size testing equipment. Example equipment includes dynamic light scattering equipment and laser diffraction equipment, examples of which are commercially available, e.g., from Malvern Panalytical Ltd. Malvern, U.K.

Example concentrated dicyandiamide products (“liquid concentrates”) exhibit particle size stability, i.e., a limited increase in average particle size caused by Ostwald's ripening as measured by a change in average particle size of suspended particles during a storage period. An initial average particle size of particles of a suspension can be measured at a time of preparing the suspension, e.g., or soon (within an hour, 12 hours, or 24 hours) after particles are dispersed and suspended in a liquid suspension; the result of this particle size measurement can be referred to as the “initial” average particle size of the suspension. Average particle size measurements of the particles of the suspension can be performed again after different storage test periods and compared to the initial average particle size of the suspension. According to useful or preferred examples of concentrated dicyandiamide products of the present description, the average particle size of dicyandiamide particles suspended in a concentrate does not increase by more than 20, 10, 8, 5, or 3 percent compared to an initial average particle size of particles in the suspension, after a storage test period.

Example dicyandiamide concentrate products contain solid dicyandiamide particles homogeneously suspended within the liquid medium. During storage of a suspension, the solid particles that are initially suspended and homogeneously dispersed throughout the liquid medium can tend to “settle out” of the suspension due to gravity, i.e., become no longer dispersed within the bulk liquid medium, and fall due to the force of gravity to a bottom of a container that contains the suspension and settle and accumulate at the bottom. Having particles settle out of the suspension during storage is undesirable because the settled particles must be re-dispersed before the suspension is used, which requires additional processing, or the settled particles may otherwise be lost and go unused when the suspension is removed from the container while the settled particles remain in the container.

Preferred liquid concentrates are stable and remain homogeneous over one or more of the described storage test periods without the need to re-disperse initially-suspended dicyandiamide particles that settle out of the suspended state and accumulate at a bottom of a container due to gravitational settling. Example concentrates remain homogeneous and do not have any significant amount of solid dicyandiamide particles remaining at a bottom of a container after the liquid concentrate is removed from the container for use, e.g., by pouring the concentrate from a top opening of the container, after one or more storage test periods.

As one test for the presence of dicyandiamide settled out of a suspension during storage following a storage test period, an edge of a stainless steel spatula can be dipped into a suspension that has been held within a container such as a glass jar with a top opening, and dragged across the bottom surface of the jar in a manner that will scrape dicyandiamide particles that have accumulated on the bottom surface of the jar, onto the spatula. If an edge of a spatula that is dragged across the bottom of a stored sample container does not pick up or disturb any visually detectable (without magnification) amount of settled dicyandiamide particles, the sample can be considered to pass this test and is considered to be stable against gravitational particle settling for the storage test period.

As a different test for the presence of dicyandiamide settled out of a suspension during storage, multiple samples of an example liquid concentrate can be stored separately in multiple clear glass jars for different storage test periods. After a storage test period, the liquid concentrate can be emptied from the jar by pouring the concentrate out of the top opening of the jar. After pouring the liquid concentrate from the jar, the bottom surface of the jar is viewed visually, without magnification, to check for the presence of dicyandiamide particles settled at the bottom of the glass jar. If no residual amount of solid dicyandiamide is detectable visually on the container bottom, without magnification, the sample can be considered to pass this test and is considered to be stable against gravitational particle settling for the storage test period.

By another measure, stability of a liquid concentrate against gravitational particle settling can be measured by measuring a reduction in an amount of dicyandiamide particles that remain suspended in the liquid medium as reflected by a measured change in concentration of dicyandiamide in the liquid concentrate after a storage test period. During storage, if particles of dicyandiamide fall out of suspension within the liquid concentrate and settle to a bottom of a container that holds the liquid concentrate, the amount of dicyandiamide particles remaining in the suspension is reduced and the concentration of dicyandiamide in the liquid suspension is measurably lower compared to the concentration of dicyandiamide in the originally-prepared suspension (referred to as the “initial” concentration).

The amount (e.g., concentration) of suspended dicyandiamide particles contained in a liquid concentrate is preferably stable during storage and does experience a significant reduction during a storage test period by dicyandiamide particles settling out of suspension and accumulating at a bottom of a container. In preferred liquid concentrates, a sample of liquid concentrate taken from a top level of a storage container (e.g., a top quarter of a volume of liquid concentrate contained in a container) will have a concentration of dicyandiamide that is reduced by not more than 5, 3, 2, 1, or 0.5 percent after one or more test storage periods as specified, compared to an “initial” concentration of dicyandiamide in the concentrate (calculated or measured within an hour of preparation). For clarity, for a concentrate that contains an initial concentration of dicyandiamide equal to 30.0 weight percent dicyandiamide based on total weigh concentrate, three percent of the original dicyandiamide concentration is three percent of 30.0, which is equal to 0.9 percent. After a three percent reduction in the original concentration of dicyandiamide, the concentration of dicyanamide will be 29.1 weight percent dicyandiamide based on total weight concentrate.

As another measure of stability, an amount of solid residue that accumulates at a bottom of a container that contains the concentrate can be measured over time, e.g., during storage. A concentrate that is initially prepared will have no initial amount of solid residue at a bottom of a container. During storage, solid residue, which is mostly or entirely solid dicyandiamide particles, will accumulate at the bottom of the container, e.g., due to the presence of larger-sized suspended particles that form by Ostwald's Ripening. A more stable concentrate that is less susceptible to Ostwald's Ripening will experience a relatively lower amount of solid residue accumulation at the bottom of the container over a period of storage.

In commercial use, the presence of some amount of solid residue accumulated at a bottom of a container during storage can be acceptable. The concentrate is used by removing (e.g., pouring or pumping) the concentrate from the container and combining the concentrate with fertilizer, e.g., by spraying. If too much solid residue accumulates at a bottom of a container, the amount of residue will be difficult to remove, may not be removed from the container by pumping or pouring, and is wasted. A limited amount of solid residue that is not removed from the container may be acceptable, or, alternately, the solid residue may be redispersed before removing the concentrate from the container.

An amount of solid residue that accumulates at a bottom of a container during storage or testing can be assessed in terms of the volume of solid residue that accumulates compared to the total volume of concentrate in a container. This volume may be determined by any method. As an example, after storage of a concentrate in a container the liquid component (“supernatant”) can be emptied from the container by pouring, using only gravity. An amount of solid residue will remain at the container bottom in the form of the dicyandiamide particles and an amount of liquid medium that remains with the particles. The solid residue and liquid medium component may be referred to as a slurry of the particles and liquid medium (e.g., a “sludge,” “mud,” or “slush”). The volume of the solid residue (slurry) may be measured, without drying. Desirably, the volume of the solid residue that remains in the container will be less than 50, 40, 30, or 20 percent of the total volume of the concentrate.

As yet another measure of stability, a liquid concentrate as described can have an initial viscosity (measured at a time of preparation), and a viscosity measured after one or more storage test periods, that will allow the liquid concentrate to be useful for handling and for application to or combining with a fertilizer at a range of useful temperatures, e.g., from about 35 to at least 80 or 90 degrees Fahrenheit. A preferred concentrate can exhibit a viscosity that is in a range from 5 to 3,500, e.g., at least or up to about 1,000, 2,000, or 3,000 centipoise (cps) when measured at 22 degrees Celsius using a Brookfield viscometer using an LV number 3 spindle at 12 or 30 revolutions per minute, with the measurement being taken at 60 seconds after the start of the test, both as an initial viscosity (measured soon after a concentrate has been prepared) and after one or more storage test periods. The concentrate can exhibit a viscosity in these ranges after one more multiple storage test periods.

Additionally or alternately, a viscosity of a useful or preferred concentrate, measured as described or by another viscosity testing technique, may exhibit an increase in viscosity of not more than 5, 10, or 15 percent after one or more storage test periods.

Example liquid concentrates may contain, e.g., comprise, consist of, or consist essentially of: a liquid medium that contains water, organic solvent, or a combination of water and organic solvent; dicyandiamide particles suspended in the liquid medium (with an additional amount of dicyandiamide also possibly dissolved in the liquid medium); emulsifier; suspending agent; and optional minor ingredients that may be present in a total amount of up to 5, 2, 1, or 0.5 weight percent based on total weight liquid concentrate. In other examples, the liquid concentrate can additionally contain urease inhibitor, biostimulant, micronutrient or a combination of these dissolved or suspended in the liquid medium, and may comprise, consist of, or consist essentially of: a liquid medium that contains water, organic solvent, or a combination of water and organic solvent; dicyandiamide particles suspended in the liquid medium (with an additional amount also possibly dissolved in the liquid medium); emulsifier; suspending agent; urease inhibitor biostimulant, micronutrient or a combination of these dissolved or suspended in the liquid medium; and optional minor ingredients, which may be present in a total amount of amount of up to 5, 2, 1, or 0.5 weight percent based on total weight liquid concentrate.

“Minor ingredients” may be ingredients that are useful in concentrated agricultural chemical products in small or minor amounts such as any one or more of: a dye, a preservative, a buffer, or the like. A minor ingredient such as one of these may be included in a liquid concentrate in a low amount, for example in an amount below 1 weight percent each, e.g., below 0.5 weight percent each, based on total weight liquid concentrate.

As a general matter throughout the present description, a composition as described that is said to “consist essentially of” an ingredient or a group of listed ingredients means a composition that contains the ingredient or listed ingredients with not more than an insignificant amount of other ingredients, e.g., not more than 1, 0.5, 0.1, or 0.05 total weight percent of any other ingredients based on the total weight of the specific composition. For example, a composition (e.g., concentrate) that consists essentially of: liquid medium; dicyandiamide; emulsifier; suspending agent; and up to 2 weight percent minor ingredients, refers to a composition that contains these ingredients only, and not more than 1, 0.5, 0.1, or 0.05 total weight percent of any other ingredient or ingredients, based on total weight of the composition. A composition (e.g., concentrate) that consists essentially of: liquid medium; dicyandiamide; emulsifier; suspending agent; urease inhibitor dissolved or suspended in the liquid medium; and up to 2 weight percent minor ingredients, refers to a composition that contains these ingredients only, and not more than 1, 0.5, 0.1, or 0.05 total weight percent of any other ingredient or ingredients, based on total weight of the composition.

According to the present description, a concentrated dicyandiamide product contains solid dicyandiamide particles suspended in a liquid medium that contains water (alone), organic solvent (alone), or a combination of water and organic solvent, as these ingredients are described herein. In addition to the dicyandiamide and the liquid medium, the product may contain other ingredients, including liquid or solid ingredients that may be or that may not be miscible or soluble within the liquid medium. These additional ingredients of the concentrated dicyandiamide product, which are not considered to be components of the liquid medium, may include: a dispersant, a suspending agent, dissolved or suspended urease inhibitor, biostimulant, micronutrient, and minor ingredients described herein.

Dicyandiamide particles that are useful as suspended particles of a concentrated dicyandiamide product are particles that may be partially or substantially crystalline, that contain a high concentration of dicyandiamide, e.g., at least 80, 85, 90, 95, or 97 weight percent dicyandiamide, and that preferably contain less than 5, 2, or 1 weight percent water or other materials, based on the total weight of the particles.

In addition to these features, dicyandiamide particles can be characterized by size features such as average particle size of dicyandiamide particles in a collection of particles of a suspension, and size distribution of dicyandiamide particles of the suspension.

Dicyandiamide particles are commercially available and used in raw material form as a collection of a large number of dicyandiamide particles (e.g., granules) that have a range of different sizes.

Dicyandiamide particles can be characterized by features of the sizes of particles of the collection, including average particle size, size ranges, and amounts by percent of particles in various size ranges. Particle size distribution, average particle size, etc., of dicyandiamide particles can be measured by known techniques and using known equipment. Example equipment includes dynamic light scattering laser diffraction equipment, with example equipment being dynamic light scattering equipment commercially available from Malvern Panalytical Ltd. Malvern, U.K.

In these terms, examples of useful dicyandiamide particles can have particle sizes in a micron range, with most or all particles of a collection of particles (e.g., in the form of a raw material used as an ingredient of a suspension) having a particle size below 100, 50, 30, 20, or 10 microns. The sizes of the dicyandiamide particles, e.g., in terms of size range and particle size range, can be selected to produce a concentrated dicyandiamide product that has useful or advantageous stability properties as presently described, due to being less susceptible to Ostwald's Ripening.

Dicyandiamide particles having small average particle sizes are commercially available and are known for use as curing agents, e.g., for reactions of epoxies, in adhesive products, in electronic potting and encapsulating compounds. Examples include: micro-dicyanamide having CAS number 461-58-5; ultra-micronized dicyanamide sold under the trade name Omnicure® DDA 5; ultra-micronized dicyanamide sold under the trade name Dicyanex®; and ultra-micronized dicyanamide sold under the trade name Amicure CG; as well as other examples.

The Applicant has determined that dicyandiamide particles of relatively smaller particle sizes, in a concentrate, are less susceptible to Ostwald's Ripening and can be used to prepare a concentrate that exhibits relatively improved stability (e.g., reduced particle settling during storage) compared to concentrates that contain relatively larger-sized dicyandiamide particles. The Applicant has also determined that, alternately or additionally, particles having a more narrow or a mono-modal particle size distribution (in contrast to a bi-modal or multi-modal particle size distribution), when present in a concentrate, are less susceptible to Ostwald's Ripening and can be used to prepare a concentrate that exhibits relatively improved stability compared to concentrates that contain particles having a broader particle size distribution or a bi-modal particle size distribution of dicyandiamide particles. Particles that have a particle size distribution with multiple maximum values in the density distribution are considered to be multimodal, e.g., particles that have a particle size distribution with two maximum values in the density distribution are considered to be bi-modal. Particles that have a particle size distribution with a single maximum value in the density distribution are considered to be uni-modal or mono-modal.

According to certain example concentrated dicyandiamide products, at least 90 percent (frequency) of the dicyandiamide particles in a concentrated dicyandiamide product have a particle size below 30, 20, 15, 12, 11, or 10 microns, i.e., the particles can have a particle size distribution of D90<11 microns or D90<12, 15, 20, or 30 microns. Alternately or additionally, at least 50, 60, or 70 percent of the dicyandiamide particles in a concentrated dicyandiamide product (or dicyandiamide particle ingredient thereof) can have a particle size below 10 microns; at least 40, 50, or 60 percent of the particles in a concentrated dicyandiamide product can have a particle size (D40, D50, or D60) that is below 30, 20, 15, 12, 11, 10, 9, 8, or 7 microns; e.g., particles may have D50<30, 20, 15, 12, 11, 10, 9, 8 microns or 7 microns, e.g., D50<4 microns or 5 microns.

Examples of useful dicyandiamide particles can have an average particle size (D50) in any useful range. Average particle size (D50) is a size at which 50 percent of particles in a sample are larger and 50 percent of particles in a sample are smaller. For the purpose of examples, an average particle size may be in a range from 1 to 30 microns, e.g., from 2 to 20 microns or from 2.5 to 10 microns.

In addition to average particle size, dicyandiamide particles can be selected to have a particle size distribution that results in a composition that has good stability. In example compositions, a composition that contains dicyandiamide particles that have a narrower particle size distribution, that is monomodal, or both, may exhibit greater stability compared to compositions that contain dicyandiamide particles that have a broader or a multi-modal particle size distribution.

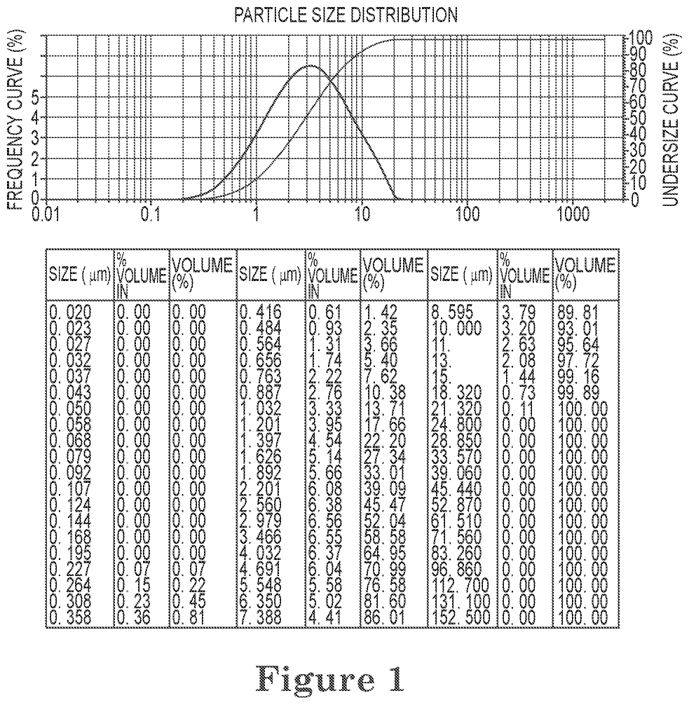

An example monomodal particle size distribution of useful dicyandiamide particles is shown at FIG. 1. The particle size distribution of dicyandiamide particles of the sample of FIG. 1 is exemplary, and particles for use according to the present description can have significantly different particle size distributions compared to the example of FIG. 1.

FIG. 1 shows two particle size distribution curves (a.k.a. particle size density curves). The first (bell-shaped) curve shows a mono-modal distribution of particle sizes of a sample of particles useful as an ingredient of a suspension, based on frequency (Frequency Curve, %) of particle sizes in microns (μm). From this curve, the measured sample contains particles in a range from approximately 0.02 microns to approximately 21 microns. The average size of the particles is approximately 2.7 microns, with about 50 percent of the particles (by volume) in the sample having a larger size and with about 50 percent (by volume) in the sample having a smaller particle size.

The second curve (Undersize Curve, %) shows the percentage (by volume) of particles in the measured sample that have a size that is below a particular size in microns As shown, 50 percent (by volume) of the particles have a particle size that is below approximately 2.7 microns (the average particle size); approximately 71 percent (by volume) of the particles have a particle size that is below approximately 4.7 microns; 90 percent (by volume) of the particles have a particle size that is below approximately 8.6 microns.

The sizes and size distribution of a collection of dicyandiamide particles can be affected and in large part can be selected and controlled by methods of preparing and sorting a collection of particles. Methods of preparing a collection of particles to have desired particle sizes and a desired particle size distribution profile include particle-size reduction steps (e.g., milling techniques) as well as steps of separating particles into different size ranges (e.g., by “attrition,” including by sieving and sorting techniques).

Examples of common particle size reduction methods include milling, which includes various types of milling techniques. Examples include techniques sometimes generally referred to as “wet milling” techniques and “dry milling” techniques. These different techniques are performed by cutting, grinding, or mechanically impacting (e.g., pounding) particles to reduce the size of particles in a collection of particles, using different types of equipment. Optionally multiple different types of equipment and multiple steps of size-reduction and particle separation can be used to achieve a desired average particle size and particle size distribution. Certain examples of types of equipment include apparatus referred to as: a rotary cutter mill, a roller mill, a hammer mill, a disintegrator, a ball mill, a fluid energy mill, among others. As background, see Sushant, S., Archana, K., “Methods of Size Reduction and Factors Affecting Size Reduction in Pharmaceutics,” Int Res. J. 2013, 4(8).

Previous concentrated dicyandiamide products include dicyandiamide in a dissolved form, in organic solvent, often dimethyl sulfonate (DMSO). Instead of dissolved dicyandiamide, a liquid concentrate according to the present description includes dicyandiamide in a form of suspended solid dicyandiamide particles. A concentrate that includes suspended dicyandiamide particles can have certain types of utility or advantages as compared to a concentrate that contains only dissolved dicyandiamide.

As one useful or advantageous feature of the concentrated dicyandiamide products described herein, an amount of the dicyandiamide that can be contained in a concentrate may be at least 30, 35, 40, 45, or 50 percent or greater, based on total weight concentrate.

| | | | Lower Use | Lower Use | | Upper Use |
|---|---|---|---|---|---|---|
| | | | Rate (L/tonne | Rate - DCD | Upper Use | Rate - DCD |
| | | DCD | (1000 | Delivered | Rate | Delivered |
| | | g/L | kilograms) | (g/tonne | (L/tonne | (g/tonne |
| Product | Form | (concentrate) | tank mix) | tank mix) | tank mix) | tank mix) |
| DCD, 30% | Solution | 348.6 | 2.1 | 732.1 | 8.3 | 2893.4 |
| DCD, 30% | Suspension | 333 | 2.2 | 732.1 | 8.7 | 2893.4 |
| DCD, 50% | Suspension | 590 | 1.2 | 732.1 | 4.9 | 2893.4 |
| NBPT (15%)/DCD | Solution | 165.3 | 2.0 | 330.6 | 4.0 | 661.2 |
| (15%) | | | | | | |
| NBPT (15%)/DCD | Hybrid | 169.5 | 2.0 | 330.6 | 3.9 | 661.2 |
| (15%) | | | | | | |

The concentration of dicyandiamide in a liquid concentrate as described may be any useful concentration, up to or greater than 20, 30, 35, 40, 45, 50, or 55 weight percent dicyandiamide, or higher, as desired, based on a total weight of the liquid concentrate. These concentrates may also contain other useful ingredients such as urease inhibitor, biostimulant, micronutrient, etc., in combination with the suspended dicyandiamide. Advantageously, a relatively higher concentration of dicyandiamide in a concentrated dicyandiamide product may result in improved efficiency during handling and use, reduced overall cost, or both. During use, the amount by volume of the liquid concentrate product that is combined with a given amount of fertilizer may be reduced. The need to handle, store, and process a reduced total volume of concentrated dicyandiamide product relative to an amount of fertilizer with which the product is combined can allow for efficiencies and cost reductions with respect to transport, storage, handling, and equipment needed to combine the liquid concentrate with fertilizer.

Cost savings also occur when producing a product that has a relatively higher concentration of dicyandiamide versus products with lower concentrations. As a single factor, the more highly-concentrated product contains relatively lower amounts of non-dicyandiamide ingredients per amount of dicyandiamide ingredient, with a savings in cost based on the reduction of non-dicyandiamide ingredients.

In other versions of the described concentrates, the amount of dicyandiamide may be lower, which can more easily allow the concentrate to contain other useful ingredients sch as urease inhibitor, biostimulant, micronutrient, or other useful ingredients in combination with the suspended dicyandiamide. In these concentrates, which contain a combination of dicyandiamide and urease inhibitor, biostimulant, or micronutrient, the amounts of the various ingredients may be in any useful range. An amount of dicyandiamide may be any amount of at least 1 weight percent, e.g., at least 2, 3, or 5 weight percent up to or in excess of 25, 30, or 35 weight percent based on a total weight of the concentrate. An amount of urease inhibitor, biostimulant, micronutrient, or a combination of these may be an amount of at least 0.5 or 1 weight percent, e.g., at least 2, 3, or 5 weight percent up to or in excess of 15, 20, or 25 weight percent, based on a total weight of the concentrate.

Urease inhibitors (e.g., NBPT) are available commercially at relatively high purities, e.g., at a purity of at least 90, 95, or 99 weight percent.

The concentrate may be in the form of a liquid concentrate that contains dicyandiamide particles suspended in a liquid medium. In some versions of these compositions, the liquid medium may include only water (a small amount of organic solvent may be present in the composition if the solvent is contained in an ingredient of the concentrate, e.g., a small amount of solvent contained in a thickener, dye, or suspending agent ingredient). In other versions of these compositions, the liquid medium may contain water combined with organic solvent. In still other versions of these compositions, the liquid medium may contain only organic solvent (a small amount of water may be present in the composition if the water is contained in an ingredient of the concentrate, e.g., a small amount of water contained in the DCD ingredient).

In other example compositions, a composition may be in the form of a liquid concentrate that contains dicyandiamide particles suspended in a liquid medium, with the liquid medium also containing dissolved or suspended urease inhibitor, biostimulant, or a combination of urease inhibitor and biostimulant. In some versions of these compositions, the liquid medium may include only water (a small amount of organic solvent may be present in the composition if the solvent is contained in an ingredient of the concentrate, e.g., a small amount of solvent contained in a thickener, dye, or suspending agent ingredient). In other versions of these compositions, the liquid medium may contain water combined with organic solvent. In still other versions of these compositions, the liquid medium may contain only organic solvent (a small amount of water may be present in the composition if the water is contained in an ingredient of the concentrate, e.g., a small amount of water contained in the DCD ingredient).

The term “liquid medium” refers to a liquid component of the concentrate that forms a major portion of the concentrate and that carries and suspends the dicyandiamide particles. The liquid medium may contain water (only), organic solid (only), or water and organic solvent; example liquid mediums can consist of or consist essentially of water (only), or organic solid (only), or a combination of water and organic solvent. Other liquid or dissolved ingredients may be included in a concentrated dicyandiamide product but are not considered to be components of the liquid medium. These other liquid or dissolved ingredients may include a dispersant, a suspending agent, and minor ingredients as described herein.

The amount of water in the liquid medium can be any amount that is useful to form a concentrate product as described. On a basis of an amount of water included in a liquid medium of a liquid concentrate (not all ingredients of the concentrate), example amounts of water may be in a range from 0, 1, 5, 10, 20, or 30 weight percent, up to or in excess of about 50, 70, 80, 90, 95, or even up to 100 weight percent water based on total weight liquid medium. These described amounts of water are based on a total weight of liquid medium of the concentrate, i.e., water and optional organic solvent only, and do not include the weight of other ingredients that will be present in a dissolved or non-solid form in a liquid concentrate such as dispersant, suspending agent, another dissolved active ingredient (e.g., urease inhibitor such as NBPT), preservative, dye, or others.

The amount of water can also be described on a basis of the amount of water that is part of a total weight of a concentrated dicyandiamide product. On this basis, a concentrated dicyandiamide product (all ingredients) may contain water, as example amounts, in a range from 1, 3, 5, or 10 weight percent, up to 20, 30, 40, 50, 70, or 80 weight percent based on total weight concentrated dicyandiamide product.

A liquid medium may contain non-aqueous solvent in combination with water. A non-aqueous solvent refers to any of a variety of known liquid solvent materials that are often referred to in the chemical and agro-chemical arts as “organic solvents.” Organic solvents are organic (hydrocarbon-containing) compounds that exist in a liquid form at room temperature and that may tend to be volatile or flammable. For use in a concentrate as described, an organic solvent can also be miscible with water within a liquid medium and is either miscible with or able to solubilize (i.e., fully dissolve) other ingredients of a liquid concentrate, except for the suspended dicyandiamide particles.

In still other versions of compositions as described, a liquid medium may contain only organic solvent and does not require any significant amount of water. The composition may contain not more than a small or insignificant amount of water, e.g., as may be present in other ingredients used to form the composition, e.g., dicyandiamide may contain a small amount of adventitious water. The composition may contain an amount of water that is less than 3, 2, or 1 percent, with the water being present mainly by being present in a different (non-water) ingredient of the composition.

Non-aqueous solvent, if included in a liquid medium, can be any organic solvent that is liquid at room temperature, may be substantially miscible with water (if a liquid medium also contains water), and will provide a liquid medium that is useful to suspend dicyandiamide particles as described.

Examples of useful organic solvents include one or a combination of lower molecular weight alcohol, polyol, or ether compounds. These types of compounds are of a class of lower molecular weight hydrocarbon compounds that are made of carbon, hydrogen, and oxygen atoms, with the oxygen atoms being present as part of an ether linkage (e.g., —CH₂—O—CH₂—) or as an alcohol substituent (e.g., —CH₂—OH), wherein a compound does not contain unsaturation or non-oxygen heteroatoms (e.g., nitrogen, sulfur, halogen, etc.), and wherein the carbon and hydrogen atoms (other than the hydrogen atom associated with an —OH group) are in the form of branched or unbranched, non-cyclic, alkyl or alkylene groups (e.g., —CH₂CH₃ or —(CH₂)ₓ— groups).

In some embodiments, the organic solvent is a polyol such as glycerol, sorbitol, or glycol such as ethylene glycol, propylene glycol, or dipropylene glycol. In some embodiments, the organic solvent is a polyol ether such as dipropyleneglycol monomethylether or diethyleneglycol monomethylether.

An organic solvent may be a glycol ether, e.g., a mono-alkyl ether or a di-alkyl ether of an alkylene glycol, such as a mono- or di-alkyl ether of ethylene glycol, mono- or di-alkyl ether of propylene glycol, etc. Generally, these compounds can be described by the formula:

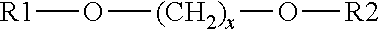

wherein R1 is a straight or branched alkyl group optionally containing a saturated or unsaturated ring structure (e.g., a lower alkyl group such as methyl, ethyl, propyl, or butyl); R2, independently of R1, is hydrogen or a straight or branched alkyl group optionally containing a saturated or unsaturated ring structure (e.g., a lower alkyl group such as methyl, ethyl, propyl, or butyl); and x is an integer such as 2, 3, 4, etc.

Another example solvent is isophorone:

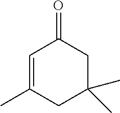

also known as 3,5,5-trimethyl-2-cyclohexene-1-one (CAS Number 78-59-1).

Other examples of organic solvent may be an alcohol amine such as ethanolamine, diethanolamine, triethanolamine, monoisopropanolamine, or diisopropanolamine.

Other examples of organic solvent may be esters such as ethyl lactate, butyl acetate, and ethyl 3-ethoxy propionate. In some embodiments, an organic solvent may be a carbonate ester solvent such as a cyclic carbonate such as propylene carbonate, ethylene carbonate, or trimethylene carbonate, a dialkyl carbonate like dimethyl carbonate.

Examples alkanols include methanol, ethanol, propanol, isopropanol, isobutanol, and other relatively low molecular weight alkanols, meaning alcohol compounds that contain 8 or fewer total carbon atoms, e.g., 6 or fewer total carbon atoms, and that are liquid at room temperature (e.g., 70 degrees Fahrenheit).

Example polyol compounds useful as the non-aqueous solvent may include alkylene glycol compounds such as ethylene glycol, propylene glycol, butylene glycol, glycerol (i.e., glycerin), and other diols and triols (optionally containing a ketone linkage, i.e., glycol ethers) made from alkyl or alkylene groups having 5 or fewer carbon atoms. Certain preferred polyols can contain 8 or fewer total carbon atoms, e.g., 6 or fewer total carbon atoms.

Examples of other common organic solvents that may be useful as an organic solvent in a liquid medium include toluene, acetone, methyl acetate, ethyl acetate, hexane, methyl-ethyl-ketone, among others.

Still other example organic solvents include organic aprotic solvents such as dialkyl sulfoxides, diaryl sulfoxides, alkylaryl sulfoxides, sulfolanes, and carbonate esters. Exemplary dialkyl sulfoxides include dimethyl sulfoxide, diethylsulfoxide, di-n-propyl sulfoxide, diisopropyl sulfoxide, diisobutyl sulfoxide, methyl ethyl sulfoxide, di-n-butyl sulfoxide, methyl isobutyl sulfoxide, ethyl n-butyl sulfoxide, and dihexylsulfoxide.

Other example organic solvents include aprotic cyclic amide solvent such as an N-alkyl pyrrolidones. An N-alkyl pyrrolidone is an organic five-membered heterocyclic ring compound with one nitrogen atom per ring, the five bonds of the ring being single (saturated) bonds, the compound including an oxygen atom bonded to a carbon atom of the ring that is adjacent to the nitrogen atom by way of a carbon-oxygen double bond, and the compound including an alkyl group (R) bonded directly to the nitrogen atom, e.g.:

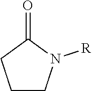

The R substituent may be an alkyl group such as a methyl, ethyl, propyl, butyl, pentyl, hexyl, heptyl, octyl, nonyl, decyl, undecyl, dodecyl, etc. The alkyl group is saturated and may be branched or unbranched.

One or a combination of different solvents can be used in a liquid medium, optionally with water, with the solvent or combination of solvents being effective to produce a concentrate as described, containing an amount of suspended (non-dissolved) dicyandiamide particles.

A useful total amount of organic solvent (a single solvent or a combination of solvents) in a liquid medium can be any amount that is effective to form a concentrate product as described, containing suspended dicyandiamide particles.

On a basis of an amount of organic solvent included in a liquid medium (not the entire concentrate), example amounts may be in a range from 0, 1, 2, 5, or 10, 20, or 30 weight percent, up to about 40, 50, or 60, 70, 80, 90, 95 or 100 weight percent organic solvent, based on total weight liquid medium. This amount of organic solvent is based on the total weight of liquid medium in a concentrate, which includes only organic solvent and optional water and does not include the weight of other ingredients that will be present in a concentrated dicyandiamide product such as dispersant, suspending agent, dissolved active ingredient (e.g., urease inhibitor such as NBPT), preservative, dye, or others.

An amount of organic solvent in a concentrate can also be described on a basis of the amount of organic solvent per total weight of a concentrated dicyandiamide product. On this basis, a concentrated dicyandiamide product (all ingredients) may contain organic solvent, as example amounts, in a range from 0, 1, 3, 5, or 10 weight percent, up to or in excess of 20, 30, 40, 50, 60, or 70 weight percent organic solvent, based on total weight concentrated dicyandiamide product.

Organic solvent is included in a concentrate as an ingredient to function as the liquid medium or a component of the liquid medium. Organic solvent may also possibly be contained in a different ingredient that is added to the concentrate, for example as an organic solvent present in a dispersant, a suspending agent, a dye ingredient, or another ingredient that contains an amount of liquid organic solvent. The amounts of organic solvent that are described as being part of the liquid medium, or part of the liquid concentrate can be considered to include any small amount of organic solvent that may be present in a different ingredient such as a dispersant or a suspending agent or a dye, or the like.

To include urease inhibitor in the concentrate, the liquid medium can include one or more organic solvents that are capable of either solubilizing or suspending a urease inhibitor. Examples of organic solvents that may be effective in a liquid medium to suspend dicyandiamide and at the same time also dissolve urease inhibitor include ethylene glycol and propylene glycol, optionally in combination with n-methyl pyrrolidone.

In a liquid medium that is part of a concentrate that includes both dispersed dicyandiamide particles and dissolved urease inhibitor, useful amounts of organic solvent and water in the liquid medium may be in any range that provides a useful concentrate. Non-limiting examples include amounts of from 5 to 50 weight percent water and 50 to 95 weight percent organic solvent, e.g., from 10 to 40 weight percent water and from 60 to 90 weight percent organic solvent based on total weight liquid medium.

In certain examples of a liquid medium that is part of a concentrate that includes dispersed dicyandiamide particles without urease inhibitor, the liquid medium may contain a majority (at least 50 weight percent, optionally at least 60 weight percent) of water and less than 50 weight percent or less than 40 weight percent organic solvent, based on total weight liquid medium. According to certain more specific examples, useful amounts of organic solvent and water in the liquid medium may be in a range from 80 to 99 weight percent water and from 1 to 20 weight percent organic solvent, e.g., from 85 or 90 weight percent to 95 or 99 weight percent water and from 1 to 15 weight percent organic solvent based on total weight liquid medium. In other examples, the liquid medium may contain 100 weight percent water and no organic solvent (less than 0.1 or 0.01, or substantially 0 weight percent organic solvent) based on total weight liquid medium.

As used herein the term “dispersant” refers to an organic compound that lowers the surface tension (or interfacial tension) between two liquids or between a liquid and a solid. A dispersant may also be referred to as a “surfactant” or an “emulsifier.” A dispersant is typically an organic amphiphilic compound that contains a hydrophobic group (e.g., a hydrocarbon (e.g., alkyl) “tail”) and a hydrophilic group.

An amount of dispersant included in a concentrated dicyandiamide product can be any amount that will be useful to function as desired, to allow the solid dicyandiamide particles to become uniformly suspended as solid particles within the liquid medium and to allow a significant amount of the dicyandiamide particles to remain in a suspended condition in a suspension within the liquid medium during storage, e.g., as measured by one or more stability tests, over one or more storage test periods as described. Exemplary amounts of dispersant in a liquid concentrate can be an amount that is less than 15 weight percent, e.g., in a range from 0.5 or 1 weight percent, up to an amount that is up to or greater than 3, 5, 7, or 10 weight percent dispersant, based on total weight liquid concentrate.

Examples of useful dispersants include polyarylphenol ethoxylates, polyarylphenol ethoxylates phosphate esters, polyarylphenol ethoxylates sulfates, alkylphenol ethoxylates, alkyl alkylphenol ethoxylated phosphate esters, and polycarboxylates. One particular example of a useful dispersant is tristyrylphenol ethoxylate phosphate ester (acid form) (CAS: 90093-37-1), including derivatives thereof. This dispersant is of a class referred to as ethoxylated polyarylphenol phosphate esters, which may be effective as dispersants in a liquid concentrate as described. Examples of ethoxylated polyarylphenol phosphate ester dispersants are described PCT International Publication Number WO 01/20986 A1 (International Application Number PCT/EP00/09134), the entirety of which is incorporated herein by reference.

Another class dispersant that may be useful is the class of amine surfactants, which includes surfactant compounds that include an amine group, e.g., a primary amine, a secondary amine, a tertiary amine, or a quaternary ammonium.

Exemplary amine surfactants can include an amine group such as octyl amine, lauryl amine, stearyl amine, oleyl amine, tallow amine, cetylamine, N-tetradecyl amine, cocoamine, hydrogenated tallow amine, di(hydrogenated) tallow amine, ethoxylated tallow amine (e.g., polyoxyethyleneamine or POEA) dicocoalkyl amine, N-tridecyltridecanamine, N-methylstearylamine, distearyl amine, and dialkyl (C8-C20) amine.

Alkyl amine surfactants are known and commercially available, including polyalkoxylated amine surfactants, for example polyoxyethyleneamine (POEA) surfactants. Example commercial alkyl amine surfactants include tallow amine surfactants sold under the trade name Surfonic® T series, Ultramina® (ethoxylated fatty amines), Tomamine (from Air Products), among others.

Other amine surfactants include those described in the following patent documents. U.S. Pat. No. 5,317,003 to Kassebaum & Berk describes compositions that contain a quaternary polyoxyethylene C6-14 di-alkylammonium surfactant having about 5 to about 50 oxyethylene units per molecule. U.S. Pat. No. 5,652,197 to Claude et al. describes quaternary polyoxypropylene oxyethylene tri-(C1-3 alkyl)ammonium surfactants having 2 to 20 oxypropylene units per molecule. U.S. Pat. No. 5,118,444 to Nguyen describes polyoxyethylene C6-20 alkylamine oxide surfactants having about 5 to about 25 oxyethylene units per molecule. U.S. Pat. No. 5,750,468 to Wright describes compositions that contain a polyoxyethylene tertiary alkyletheramine, polyoxyethylene quaternary alkyletherammonium, or polyoxyethylene alkyletheramine oxide surfactant.

Still other exemplary classes of surfactants that can be useful in a composition as described include phosphate esters, alcohol ethoxylates, alkylphenolic compounds (APEs), tristyryl phenol ethoxylates, castor oil ethoxylates, and other ethoxylated compounds. Ethoxylated compounds include castor oil ethoxylates, fatty alcohol ethoxylates, alkylphenol ethoxylates, fatty acid ethoxylates, and fatty amine ethoxylates.

Other example surfactants are known and commercially available, such as those described in U.S. Pat. No. 9,096,476. Surfactants described therein include: alcohol alkoxylates; alcohol alkoxylate sulfates; alkylphenol alkoxylates; alkylaryl sulfonates; amine oxides; amines; betaine derivatives; carboxylated alcohol or alkylphenol alkoxylates; ethoxylated amines; ethoxylated fatty acids; ethoxylated fatty esters or oils; fatty esters; glycerol esters; phosphate ester surfactants; sarcosine derivatives; silicone-based surfactants; sorbitan derivatives; sucrose and glucose derivatives; sulfates or sulfonates of alkoxylated alkylphenols; sulfates of alcohols; tristyrylphenol alkoxylates; polyethoxylated aliphatic phenols; polymers of ethylene or propylene oxides; and ethoxylated triglycerides or seed oils.

Alcohol ethoxylate surfactants are well-known and can be nonionic at typical use conditions. Also known as fatty alcohol ethoxylates, these surfactants include an alkyl group (e.g., a linear alkyl group) connected to an ethoxy group (i.e., polyethoxy chain). The surfactants include a hydrophobic tail portion (fatty alcohol part) and a hydrophilic polar head groups (ethoxy chain part). Surfactant molecules vary based on the chain length of the alkyl group and the degree of ethoxylation of the ethoxy portion. Surfactant ingredients may include molecules having a range of carbon chain length of the alkyl group and a range of ethoxylation of the ethoxy portion.

Alkylphenolic compounds, including alkylphenolic ethoxylates, which includes derivatives such as phosphates and sulfates, are also well known. These compounds can include a hydrophobic alkyl portion attached to a phenolic portion, and an ethoxylate portion (alkylphenolic ethoxylates), a phosphate, or a sulfate. Example compounds include nonionic nonylphenol (NP) and nonylphenol ethoxylates (NPE).

Tristyryl phenol ethoxylates, also known as polyethylene glycol mono(tristyrylphenyl)ethers, which is understood to include derivatives such as phosphate (e.g., polyoxyethylene tristyrylphenol phosphate, a.k.a. polyoxyethylene phenylalkylphenol ether phosphate) and sulfate compounds, are known chemical compounds that include an ethoxylate portion attached to a tristyryl-substituted phenol. These are nonionic and can vary based on the degree of ethoxylation.

Castor oil ethoxylates are another well-known class of chemical compounds that include an ethoxylate portion, in this case being attached to a castor oil fatty acid. These compounds are nonionic and can vary based on the degree of ethoxylation.

Phosphate ester surfactant compounds contain a phosphate group and one or more organic groups associated with the phosphate group. Exemplary phosphate ester compounds include a phosphate group substituted by one or two alkyl, alkoxy (e.g., ethoxylate) groups, or aromatic groups. Surfactant compositions can include mono phosphate esters, di-esters, and mixtures of mono- and di-esters. The organic group may be any useful organic substituent such as a straight or branched alkyl group; a straight or branched alkoxyl group; or an aromatic group such as a cyclic aromatic group, which may be substituted or un-substituted, e.g., an alkylphenol; or the like. These compounds may be neutral or may exhibit an anionic charge at typical use conditions for agricultural applications (e.g., neutral to acidic pH). These compounds can be produced by known methods, such as by phosphation of ethoxylated, aliphatic, or aromatic alcohols.

Certain more specific phosphate ester surfactants include alkyl phosphate esters and alkoxy phosphate esters, for example including an alkyl or alkoxy substituent that is straight or branched, that optionally contains one or more oxygen heteroatom or oxygen substitution, and that can contain from 1 to 20 carbon atoms, e.g., from 5 to 18 carbon atoms, or from 7 to 15 carbon atoms. One particular example is tridecyl alcohol phosphate ester (C₁₃H₃₁O₅P), which has a CAS number of 77031-08-4 (aka tridecan-1-ol-phosphoric acid (1:1); phosphoric acid tridecan-1-ol; 1-tridecanol, phosphate). Other examples include alkyl phenol phosphate esters, i.e., phosphate esters having an alkyl phenol hydrophobe, e.g., wherein the alkyl group of the alkyl phenol hydrophobe can be any alkyl group, such as a C1 through C20 straight or branched alkyl group, e.g., a C2 trough C15 or a C3 through C12 straight or branched alkyl group. Various phosphate ester compounds are described in U.S. Pat. Nos. 3,033,889, 5,167,767, and 6,566,408.

Examples of non-ionic emulsifiers include alkoxylated castor oil, alkoxylated polyarylphenols, alkoxylated alkyl phenols, alkoxylated alkylarylphenols, and alkoxylated fatty alcohols, as well as mixtures thereof. More specific examples include alkoxylated acetylenic diols, polyoxyalkylene mono- and di(C8-20 alkyl)phenylethers, polyoxyalkylene di- and tristyrylphenylethers, block copolymers of ethylene oxide and propylene oxide and C2-6 alkyl adducts thereof, sorbitan C8-20 mono-, di- and tri(C8-20 fatty acid) esters, polyoxyalkylene sorbitan mono-, di- and tri(C8-20 fatty acid) esters, sucrose esters and C8-20 alkyl polyglycosides.

Commercially available examples of non-ionic emulsifiers include the following: those commercially available under the trade names POLYSORBATE 80 (aka, Tween 80; Polyoxyethylene (20) sorbitan monooleate) (CAS No.: 9005-65-6) (HLB=15); Tween 20 (Polyoxyethylene sorbitan monolaurate) (CAS No.: 9005-64-5), Tween 85 (aka emulsifier T-85) (CAS No.: 9005-70-3) (HLB=11.0); those sold BY Dow Chemical under the trade name TRITON (e.g. TRITON X-100) (aka octylphenol ethoxylate) (HLB=13.4).

Examples of useful anionic emulsifiers include calcium-dodecylbenzene sulfonate, di-octyl sulfosuccinate, sulfated or phosphated alkoxylated fatty alcohols, sulfated or phosphated alkoxylated alkylaryl phenols, and combinations of these. Some more specific examples include C8-20 alkyl carboxylates including fatty acids, C8-20 alcohol sulfates, C8-20 alcohol phosphate mono- and diesters, C8-20 alcohol and (C8-20 alkyl)phenol polyoxyethylene ether carboxylates, sulfates and sulfonates, C8-20 alcohol and (C8-20 alkyl)phenol polyoxyethylene phosphate mono- and diesters, C8-20 alkylbenzene sulfonates, naphthalene sulfonates and formaldehyde condensates thereof, lignosulfonates, C8-20 alkyl sulfosuccinates and sulfosuccinamates, C8-20 alkyl polyoxyethylene sulfosuccinates and sulfosuccinamates, and C8-20 acyl glutamates, sarcosinates, isethionates and taurates. Cationic counterions accompanying an anionic emulsifier can preferably be monovalent, e.g., hydrogen, sodium, potassium, ammonium, and monovalent organic ammonium cations (isopropylamine).

Commercially available examples of non-ionic emulsifiers include the following: BIO-SOFT® N-411 (linear dodecylbenzensulphonic isopropylamine salt); tristyrylphenol ethoxylate (e.g., sold under the trade name LUCRAMUL, from Levaco Chemicals).

A liquid concentrate of the present description may also include a suspending agent, which is a material that will be present in the liquid medium either in a dissolved or a suspended form, and that functions to support the suspended particles of dicyandiamide and stabilize those particles within the liquid concentrate. Preferred suspending agents (also referred to as “suspension agents,” “stabilizing agents,” or the like) are effective to provide a liquid concentrate as described, containing desired amounts of suspended dicyandiamide particles throughout the liquid medium, with the liquid concentrate being in the form of a flowable, pumpable, and stable (as described) concentrate that can be efficiently applied to or combined with fertilizer.

Many different examples of suspending agents are known and are commercially available. These include water-soluble polymers that become dissolve in the liquid medium of a suspension, as well as particulate-type suspending agents that are present as small-sized solid materials in the liquid medium that are also effective to support and stabilize other types of particles (e.g., dicyandiamide particles) suspended within a liquid medium. Examples of these types of suspending agents include silica materials, clay, and the like.

One general class of suspending agent is the class of water-soluble polymers that are effective for this purpose. Specific examples are known in the chemical and chemical composition arts and include water-soluble (i.e., hydratable) polymers that are of a relatively high molecular weight and that are known to increase viscosity of an aqueous medium, upon hydration, in a manner that is effective to stabilize particles suspended within the same aqueous medium. These may be natural or modified natural polymers that include polysaccharides, modified polysaccharides, and related polymeric materials sometimes referred to generally as xanthan gums, cellulosic polymers, and other types of specific or general polysaccharides. Specific examples of such polymers include carboxymethyl hydroxyethyl cellulose (CMHEC), carboxymethylcellulose, other cellulosics and cellulosic derivatives such as hydroxyethylcellulose and hydroxypropylcellulose; xanthan gum; modified starches; succinoglycan; scleroglycan; o-carboxychitosans; polyvinylsaccharides; and similar biopolymers and mixtures thereof.

A class of preferred suspending agents is the class of “xanthans,” e.g., “xanthan gums.” Xanthan gum is a polysaccharide gum produced by Xathomonas campestris and contains D-glucose, D-mannose, and D-glucuronic acid, as the main hexose units; the polymers also contain pyruvate acid and are partially acetylated.

A second general class of materials that can be useful as a suspending agent as described is the class of solid particulate materials that are known to be effective for stabilizing suspended particulate materials in a liquid medium. Specific examples include silica (e.g., fumed silica), inorganic colloidal or colloid-forming particles, and various clays such as organophilic clays.

Examples of clays that may be useful as a suspending agent include inorganic clay materials such as aluminosilicate or magnesium silicate; colloid-forming clay, typically, a smectite (also known as montmorillonoid) clay; an attapulgite (also known as palygorskite) clay; among other examples. These and other useful clay materials can be described as expandable layered clays, wherein the term “expandable” as used herein in reference to such clay relates to the ability of the layered clay structure to be swollen, or expanded, on contact with water.

The amount of stabilizing agent present in a concentrate composition can be any amount that will produce a useful liquid concentrate, which is preferably stable as described. Example amounts (on a dry basis) may be in a range from about 0.01 to 10 weight percent stabilizing agent based on total weight liquid concentrate, for example from about 0.05 to 7, e.g., from 0.1 to 1, 3, or 5 weight percent based on total weight liquid concentrate.

Exemplary concentrates also do not require and may specifically exclude active herbicide, pesticide, and fungicide, e.g., can contain less than 2, 1, 0.5, 0.1, or 0.05 weight percent total herbicide, pesticide, and fungicide based on total weight concentrate. A concentrate may in particular exclude a herbicide, pesticide, or fungicide that is synthetically prepared, including pesticide, herbicide, and fungicide products that are regulated by and that require registration to be sold in the United States with the Environmental Protection Agency under the Federal Insecticide, Fungicide, and Rodenticide ACT (FIFRA). Examples include synthetic compounds within the classes of organochlorines (DDT, toxaphene, dieldrin, aldrin), organophosphates (ciazinon, glyphosate, malathion), carbamates (carbofuran, aldicarb, carbaryl), and pyrethroids (fenpropanthrin, deltamethrin, cypermethrin); synthetic auxin herbicides (2,4-D, dicamba, chlopyralid, triclopyr, quinclorac), among others.

Optionally, examples of useful concentrates may also exclude compounds that are not federally regulated in the United States under FIFRA, but that are natural or naturally derived that may have a herbicidal, pesticidal, or fungicidal effect, or may act as a growth regulator (PGR) such as certain types of amino acids and plant growth hormones. Specific examples include the classes of cytokinins and gibberellins. Example liquid concentrates may contain less than 2, 1, 0.5, 0.1, or 0.05 total weight percent of one or more of these compounds, based on total weight liquid concentrate.

Exemplary concentrates do not require and may specifically exclude a fertilizer ingredient, including nitrogen-based fertilizers. Example liquid concentrates can contain less than 2, 1, 0.5, 0.1, or 0.05 weight percent nitrogen-based fertilizer such as any of the nitrogen-based fertilizers described herein as useful in combination with the present liquid concentrates. While not requiring fertilizer as an ingredient of a liquid concentrate, a concentrate as described can take a form that does not contain nitrogen-based fertilizer, but is useful when combined with a fertilizer, such as a nitrogen-based fertilizer.

A liquid concentrate as described will be understood to be useful in agricultural applications according to previous uses of dicyandiamide as a nitrification inhibitor, or according to previous uses of dicyandiamide as a nitrification inhibitor in combination with urease inhibitor. For example, a liquid concentrate as described can be included in or combined with a nitrogen-based fertilizer compositions to form a fertilizer product, which can then be applied to a crop, field, or soil.

The nitrogen-based fertilizer may be in any form, such as in solid particles (e.g., “prills”), in a liquid form (such as a liquid urea-nitrogen fertilizer), or in a molten form such as molten urea.

According to example products and methods, a liquid concentrate can be applied to solid fertilizer particles, e.g., pellets, granules, “prills,” or the like, to form coated fertilizer particles. The coated fertilizer particles, which contain nitrogen-based fertilizer, dicyandiamide, and optional urease inhibitor, can subsequently be applied to a field, which may be an unplanted field or a planted field. A crop plant of a planted field may be emerged (e.g., sprouted) or not yet emerged.

The liquid concentrate can be combined with a variety of different types of solid, nitrogen-based (nitrogen-containing) fertilizer particles. Suitable examples contain nitrogenous compound such as urea, a nitrate salt, ammonium salt, e.g.: ammonium nitrate, ammonium sulfate, ammonium thiosulfate, ammonium polysulfide, ammonium phosphates, ammonium chloride, ammonium bicarbonate, anhydrous ammonia, calcium nitrate, nitrate soda, calcium cyanamide. As one example, a nitrogen-based fertilizer may be in a solid particulate (e.g., granule, prill) form.

A composition as described may be applied by spraying the composition onto surfaces of the solid fertilizer particles, for example by spraying the composition onto a collection of fertilizer particles contained in a large mixer, while mixing the particles and the sprayed coating composition.

A resultant fertilizer product in the form of coated fertilizer particles can be applied to a field directly to un-planted soil, as can be a typical mode of fertilizing a field for subsequent planting. The coated fertilizer particles may alternately be applied to a planted field either before or after emergence of crop plants. The coated particles may be applied in solid particle (non-dissolved) form, as is common with nitrogen and other NPK particle-type fertilizers. The coated particles may be applied by use of a spreader, at a useful application rate, e.g., by a “broadcast” or “top dressing” type of application technique using conventional application equipment (e.g., a “broadcast spreader”).

Alternately, a liquid concentrate can be combined with liquid fertilizer such as a liquid urea-based fertilizer. Exemplary fertilizers into which the liquid concentrate can be incorporated include urea-based fertilizers such as: urea (46-0-0), urea ammonium nitrate solutions (UAN) (28-32 percent), and urea ammonium sulfate (33-0-0-12S), among others.

In other example uses, the liquid concentrate can be combined with molten urea.

### EXAMPLES

Aqueous Dicyandiamide Suspension with No Urease Inhibitor

Example concentrated dicyandiamide product with suspended dicyandiamide, in an aqueous liquid medium (optionally containing no organic solvent), and no urease inhibitor can contain ingredients as follows.

| | Example ranges (parts by weight | | |
|---|---|---|---|
| | solids based on 100 parts by | | |
| Ingredient | weight of these listed ingredients) | | |
| Water | 20 to 80 | 30 to 75 | 40 to 70 |
| DCD (mostly suspended, | At least 20 | 20 to 50 | 25 to 40 |
| with a small amount dissolve | | | |
| in the liquid medium) | | | |
| Dispersant | 0.1 to 7 | 0.3 to 5 | 0.5 to 3 |
| Suspending Agent | 0.05 to 3 | 0.07 to 2 | 0.1 to 1.5 |
| Minor ingredients | <2 | <2 | <2 |
| Total of these listed | 100 | 100 | 100 |
| ingredients | | | |

The following example DCD Suspension concentrate was formed as follows:

Charge water 39.7 weight percent water.

Prepare a solution of 0.75 weight percent xanthan gum in 39.25 weight percent water.

Charge: the dispersant, preservative, and solution of xanthan gum in water.

Agitate the mixture to form a homogeneous liquid solution.

Add the micronized DCD particles (D90 is <10 micron, prepared by dry milling).

Continue agitation of the solution and DCD particles until all the of the particles are fully dispersed and no large, undispersed agglomerates of DCD remain.

### DCD Suspension

| | | Weight percent |
|---|---|---|
| Ingredient | | of Suspension |
| Water | | 67.1 |
| Micronized dicyandiamide | D90 is <10 micron | 30.0 |
| Dispersant | Tristyrylphenol ethoxylate | 2.0 |
| Suspending Agent | Xanthan Gum* | 0.30 |
| Dye/pigment | | 0.50 |
| Preservative | Proxel GXL | 0.10 |
| | | 100.0 |

*In this example, the 0.3 weight percent xanthan gum was pre-dispersed in 39.7 weight percent water (0.75 weight percent xanthan gum in water) and the combination of the xanthan gum and water was added to the other ingredients. The amount of xanthan gum solids in the suspension is 0.3 weight percent. The amount of water (67.6 weight percent) listed as water in the suspension includes the amount that is pre-combined with the xanthan gum.

The example DCD suspension was tested and has been shown to be stable for up to 24 months: During this storage period, using different test conditions (see below), tested samples have minimal phase separation at a top of a container, no visible sedimentation (settled dicyandiamide particles) on the bottom of the container, an acceptably low change in viscosity (+/−10%), and no significant chemical degradation of the active (DCD). Test conditions were, independently: 45 deg C., RT (˜22 deg C.), 0 deg C., and three freeze/thaw cycles (RT/−16 deg C.).
Dicyandiamide Suspension with Dissolved Urease Inhibitor

Example concentrated dicyandiamide product with dicyandiamide particles suspended in an aqueous liquid medium (optionally with no organic solvent), and with urease inhibitor dissolved in the liquid medium, can contain ingredients as follows.

| | Example ranges (parts by weight | | |
|---|---|---|---|
| | solids based on 100 parts by | | |
| Ingredient | weight of these listed ingredients) | | |
| Water | 1 to 20 | 2 to 15 | 3 to 15 |
| DCD (mostly suspended, | At least 3 | 5 to 40 | 10 to 35 |
| with a small amount dissolve) | | | |
| Organic Solvent | 20 to 60 | 25 to 55 | 30 to 50 |
| Urease Inhibitor | 0.5 to 25 | 2 to 15 | 3 to 10 |
| Dispersant | 0.1 to 7 | 0.3 to 5 | 0.5 to 3 |
| Suspending Agent** | 0.05 to 3 | 0.07 to 2 | 0.1 to1.5 |
| Minor ingredients | <2 | <2 | <2 |
| Total of these listed | 100 | 100 | 100 |
| ingredients | | | |

**amount, solids

DCD Suspension with Dissolved Urease Inhibitor

| | | Weight percent |
|---|---|---|
| Ingredient | | of Suspension |
| Water | | 9.925 |
| Micronized dicyandiamide | | 23.0 |
| NBPT urease inhibitor | | 17.0 |
| Dispersant | Tristyrylphenol ethoxylate | 2.0 |
| Organic Solvent | Ethylene glycol | 24.0 |
| Organic Solvent | n-methyl pyrrolidone | 24.0 |
| Suspending Agent** | Xanthan Gum* (0.75 | 0.075 |
| | weight percent in water) | |
| | | 100.0 |

*The 0.75 weight percent xanthan gum was pre-dispersed in 9.925 weight percent water (0.75 weight percent xanthan gum in water) and the combination of the xanthan gum and water was added to the other ingredients.

### Non-Aqueous Dicyandiamide Suspension

Example concentrated dicyandiamide product with dicyandiamide particles suspended in a non-aqueous liquid medium can contain ingredients as follows.

| | | | Initial |
|---|---|---|---|
| | | Weight | Viscosity |
| | | percent of | (LV#3, |
| Ingredient | | Suspension | 30 rpm) |
| Organic solvent (e.g., | | 66.5 | 1088 |
| Propylene Glycol) | | | |
| Dispersant | Tristyrylphenol | 1.5 | |
| | phosphate | | |
| Suspending agent** | Hydroxypropyl- | 1.5 | |
| | cellulose | | |
| Micronized DCD | | 30.5 | |
| | | 100 | |
| Organic Solvent (e.g., | | 66.5 | 1908 |
| Ethylene Glycol) | | | |
| Dispersant | Tristyrylphenol | 1.5 | |
| | phosphate | | |
| Suspending agent** | Hydroxypropyl- | 1.5 | |
| | cellulose | | |
| Micronized DCD | | 30.5 | |
| | | 100 | |
| Organic Solvent (e.g., | | 66.98 | 844 |
| Propylene Glycol) | | | |
| Dispersant | Tristyrylphenol | 1.5 | |
| | phosphate | | |
| Suspending agent** | Hydroxypropyl- | 1.02 | |
| | cellulose | | |
| Micronized DCD | | 30.5 | |
| | | 100 | |
| Organic Solvent (e.g., | | 66.98 | 1672 |
| Ethylenc Glycol) | | | |
| Dispersant | Tristyrylphenol | 1.5 | |
| | phosphate | | |
| Suspending agent | Hydroxypropyl- | 1.02 | |
| | cellulose | | |
| Micronized DCD | | 30.5 | |
| | | 100 | |

**amount, solids

Non-Aqueous Dicyandiamide Suspension with Urease Inhibitor

Example concentrated dicyandiamide product with dicyandiamide particles suspended in a non-aqueous liquid medium, with urease inhibitor, can contain ingredients as follows.

| | | Weight percent |
|---|---|---|
| Ingredient | | of Suspension |
| Organic Solvent (e.g., | | 67.48 |
| Propylene Glycol) | | |
| Dispersant | Tristyrylphenol phosphate | 1.50 |
| Suspending agent** | hydroxypropylcellulose | 1.02 |
| NBPT | | 15.00 |
| Micronized DCD | | 15.00 |
| | | 100.0 |
| Organic Solvent (e.g., | | 67.48 |
| Ethylene Glycol) | | |
| Dispersant | Tristyrylphenol phosphate | 1.50 |
| Suspending agent** | hydroxypropylcellulose | 1.02 |
| NBPT | | 15.00 |
| Micronized DCD | | 15.00 |
| | | 100.0 |

**amount, solids

DCD Suspension with Biostimulant:

Example concentrated dicyandiamide product with dicyandiamide particles suspended in an aqueous liquid medium (optionally with no organic solvent) and with biostimulant dissolved or suspended in the liquid medium can contain ingredients as follows.

| | Example ranges (parts by weight | | |
|---|---|---|---|
| | solids based on 100 parts by | | |
| Ingredient | weight of these listed ingredients) | | |
| Water, organic solvent, | 20 to 70 | 25 to 65 | 30 to 60 |
| or a combination | | | |
| DCD (mostly suspended, | At least 3 | 5 to 40 | 10 to 35 |
| with a small amount dissolve) | | | |
| Biostimulant | 0.5 to 25 | 2 to 15 | 3 to 10 |
| Dispersant | 0.1 to 7 | 0.3 to 5 | 0.5 to 3 |
| Suspending Agent** | 0.05 to 3 | 0.07 to 2 | 0.1 to 1.5 |
| Minor ingredients | <2 | <2 | <2 |
| Total of these listed | 100 | 100 | 100 |
| ingredients | | | |

DCD Suspension with Dissolved Biostimulant

| | | Weight percent |
|---|---|---|
| Ingredient | | of Suspension |
| Water | | 55.6% |
| Micronized dicyandiamide | | 31.10 |
| Protein hydrolysate (7-0-0) | | 10.90 |
| Dispersant | Polyarylphenol | 2.0 |
| | ethoxlate phosphate | |
| | ester | |
| Suspending Agent** | Xanthan Gum* | 0.30% |
| | (0.75 weight | |
| | percent in water) | |
| | | 100.0 |

The following example concentrates were prepared, having dicyandiamide particles of different sizes and particle size distributions.

| | Wt % |
|---|---|
| Example 1 | |
| Water | 27.40% |
| Polyarylphenol ethoxylate phosphate ester | 2.00% |
| Xanthan Gum,* 0.75% in water | 40.00% |
| Proxel GXL | 0.10% |
| Dycure 10*** (micronized DCD) | 30.00% |
| Milled DCD, 106-250 micron | 0.50% |
| | 100.00% |
| Example 2 | |
| Water | 27.40% |
| Polyarylphenol ethoxylate phosphate ester | 2.00% |
| Xanthan Gum,* 0.75% in water | 40.00% |
| Proxel GXL | 0.10% |
| Dycure 10*** (micronized DCD) | 15.25% |
| Milled DCD, 106-250 micron | 15.25% |
| | 100.00% |
| Example 3 | |
| Water | 27.40% |
| Polyarylphenol ethoxylate phosphate ester | 2.00% |
| Xanthan Gum,* 0.75% in water | 40.00% |
| Proxel GXL | 0.10% |
| Dycure 10*** (micronized DCD) | 0.50% |
| Milled DCD, 106-250 micron | 30.00% |
| | 100.00% |

***Dycure 10 has a mean particle size of approximately 4 to 5 microns.
*The 0.75 weight percent xanthan gum was pre-dispersed in 9.925 weight percent water (0.75 weight percent xanthan gum in water) and the combination of the xanthan gum and water was added to the other ingredients. The 40 weight percent value includes water.

The Examples were stored in separate containers at 45 deg C. for eleven weeks. The samples were removed from storage and allowed to cool to room temperature (21 deg C.). The sample containers were inverted and drained by gravity to remove the liquid concentrate (supernatant) and to leave solid residue that had accumulated at the bottom of the container, in the container. The solid residue was a slurry of the particles and liquid medium and was not dried. The amount of solid residue slurry (volume solid residue slurry per total volume of concentrate) remaining in each container was measured and compared to a control sample (same as Example 1) that had not been subjected to 11 weeks of storage at 45 deg C. Eleven weeks of storage at 45 degrees Celsius may typically correlate to over 2 years of stability at room temperature.

The amounts of solid residue (slurry) measured for the control sample and for Examples 1, 2, and 3 (after heated storage) were as follows:

Control sample (not aged at elevated temperature): 9%

Example 1 (containing only dicyandiamide particles having a size distribution below 10 microns, narrow distribution): 20%

Example 2 (having 50% dicyandiamide particles smaller than 10 microns, and 50% dicyandiamide particles having a size range from 100-250 micron, i.e., a bimodal distribution): 85%

Example 3 (having mostly dicyandiamide particles having a size range from 100-250 micron—wide distribution, larger particles): 67%

As shown, Example 1 containing the 10 micron narrow, monomodal distribution of dicyandiamide particles exhibits improved stability measured as reduced particle settling during storage at elevated temperature, compared to Examples 2 and 3.

The results of Example 2 also indicate that a bimodal distribution contributes to Ostwald's Ripening, as the amount of particle settling was larger than Example 3, having essentially all larger particles.

1. A liquid dicyandiamide concentrate, comprising:
liquid medium,
dispersant,
suspending agent, and
dicyandiamide particles suspended in the liquid medium, at least 90 percent of the dicyandiamide particles having a particle size below 30 microns.

2. A concentrate of claim 1, the dicyandiamide particles having an average particle size of below 20 microns.

3. A concentrate of claim 1, wherein the concentrate exhibits stability against gravitational settling as measured by volume of settled dicyandiamide particles at a bottom of a container that contains the concentrate after a period of at least 3 months of un-agitated storage at 45 degrees Celsius.

4. A concentrate of claim 1, wherein the concentrate exhibits stability against Ostwald's ripening measured as a change in average particle size of suspended dicyandiamide particles that is less than a 10 percent increase in average particle size from an initial average particle size after a period of at least 12 months of un-agitated storage at 45 degrees Celsius.

5. A concentrate of claim 1, the dispersant comprising ethoxylated polyarylphenol phosphate ester, polyarylphenol ethoxylate, polyarylphenol ethoxylate sulfate, alkylphenol ethoxylate, alkyl alkylphenol ethoxylated phosphate ester, polycarboxylate, tristyrylphenol ethoxylate phosphate ester, ethoxylated polyarylphenol phosphate ester, or a combination thereof.

6. (canceled)

7. A concentrate of claim 1, comprising:
from 30 to 80 weight percent liquid medium, the liquid medium comprising at least 50 weight percent water based on total weight liquid medium, at least 20 weight percent dicyandiamide,
from 0.1 to 3 weight percent dispersant,
from 0.5 to 2 weight percent suspending agent,
based on total weight concentrate.

8.-11. (canceled)

12. A concentrate of claim 1, comprising:
from 30 to 80 weight percent liquid medium, the liquid medium comprising from 5 to 50 weight percent water and from 50 to 95 weight percent organic solvent, based on total weight liquid medium,
at least 5 weight percent dicyandiamide,
from 0.1 to 3 weight percent dispersant,
from 0.5 to 2 weight percent suspending agent,
based on total weight concentrate.

13. A concentrate of claim 1 comprising from 0.5 to 30 weight percent urease inhibitor, based on total weight concentrate.

14. A concentrate of claim 1, wherein the liquid medium comprises at least 20 weight percent organic solvent based on total weight liquid medium, the organic solvent comprising an alcohol, a polyol, or an ether compound.

15. A concentrate of claim 1, comprising:
from 10 to 30 weight percent dicyandiamide, and
from 10 to 30 weight percent urease inhibitor,
based on total weight concentrate.

16-17. (canceled)

18. A concentrate of claim 1, comprising biostimulant selected from a protein hydrolysate, amino acid, humic acid, and seaweed extract.

19. A concentrate of claim 1, comprising micronutrient selected from zinc manganese, copper, boron, iron, molybdenum, nickel, of a combination thereof.

20-22. (canceled)

23. A method of preparing a fertilizer product comprising nitrogen-based fertilizer and dicyandiamide, the method comprising combining a concentrate of claim 1 with nitrogen-based fertilizer.

24. A method of claim 23, wherein the nitrogen-based fertilizer is selected from liquid urea-ammonium nitrate, a solid nitrogen-based fertilizer particles, and molten urea.

25. A method of claim 24, comprising applying the concentrate to surfaces of solid nitrogen-based fertilizer particles by spraying.

26.-31. (canceled)

32. Fertilizer comprising nitrogen-based fertilizer and a concentrate of claim 1.

33. (canceled)

34.-35. (canceled)

36. A concentrate of claim 1, wherein the liquid medium comprises at least 20 weight percent water based on total weight liquid medium.

37. A method of preparing liquid dicyandiamide concentrate of claim 1, the method comprising:
providing dicyandiamide particles containing at least 90 percent dicyandiamide particles having a particle size of less than 30 microns,
combining dicyandiamide particles having an average particle size below 20 microns, with liquid medium, dispersant, and suspending agent to form a suspension comprising the dicyandiamide particles suspended in the liquid medium.

38. The method of claim 37 comprising dry milling the dicyandiamide particles.
